(19) United States
(12) Patent Application Publication
(10) Pub. No.: US 2018/0298826 A1
(43) Pub. Date: Oct. 18, 2018

(54) AIRCRAFT AUXILIARY POWER UNIT EXHAUST PIPE SEALS AND METHODS

(71) Applicant: ITT MANUFACTURING ENTERPRISES LLC, Wilmington, DE (US)

(72) Inventor: A. DAVID SANDIFORD, Lake Hughes, CA (US)

(21) Appl. No.: 15/955,615

(22) Filed: Apr. 17, 2018

Related U.S. Application Data
(60) Provisional application No. 62/486,704, filed on Apr. 18, 2017.

(51) Int. Cl. F02C 7/28; B64F 5/40; B64D 41/00

(52) U.S. Cl. CPC F02C 7/28; F05D 2220/50; B64D 41/00; B64F 5/40

(57) ABSTRACT

This disclosure relates to various seals for sealing around exhaust pipes, such as the exhaust pipe of an aircraft auxiliary power unit. The seal can include a collar portion bounding an opening that is configured to receive the exhaust pipe. The seal can include a shroud portion connected to the collar portion and extending radially outward therefrom. The seal can be configured to inflate and/or deflate to facilitate installation and/or removal of the seal from the exhaust pipe.

### CROSS-REFERENCE

This application claims the benefit of U.S. Patent Application No. 62/486,704, filed Apr. 18, 2017, which is hereby incorporated by reference in its entirety and made a part of this specification.

### BACKGROUND

### Technical Field

The devices, systems, and methods described herein relate to seals for sealing spaces in an aircraft, such as a space between an aircraft tail cone and the exhaust pipe of an auxiliary power unit (APU).

### Certain Related Art

Aircraft APUs are used to provide power for various components and systems in an aircraft (e.g., non-propulsion components and systems). APUs often direct exhaust through the tail cone of the aircraft. The exhaust can be directed out of the aircraft through an exhaust pipe extending through the tail cone.

### SUMMARY OF CERTAIN FEATURES

In many tail cone assemblies, there can be a gap between an exhaust pipe and the inside of the tail cone. The gap can allow exhaust from the exhaust pipe, debris, and/or other undesired environmental or other unwanted material to pass into the space between the exhaust pipe and the tail cone. To reduce the likelihood of entry of hazards into the tail cone assembly of the aircraft, a seal may be positioned around the exhaust pipe and/or within the tail cone. The seal can inhibit or prevent passage of material substances from entering the aircraft via the gap. Such sealing can inhibit or prevent exhaust pollutants from entering the aircraft cabin, can increase passenger/pilot comfort, and/or can reduce the chance of damage to tail cone assembly and/or other components of the aircraft.

Various embodiments relate to a seal that is configured to seal around an exhaust pipe, such as the exhaust pipe of an aircraft auxiliary power unit or other engine. The seal can include a collar portion bounding an opening. The opening can be configured to receive the exhaust pipe. The seal can include a shroud portion connected to the collar portion. The shroud portion can extend radially outward from the collar portion. The seal can include a valve connected to the collar portion. The valve can be configured to facilitate selective fluid communication with an interior of the collar portion. The collar portion can be inflatable or deflatable to engage or disengage with an outer diameter of the exhaust pipe.

In some embodiments, the collar portion is hollow. In some variants, the valve is a one-way valve or a Schrader valve. In certain implementations, the collar portion has a generally D-shaped cross-section. In some embodiments, the collar portion has an oval-shaped or polygonal-shaped cross-section. In some embodiments, the opening extends through the seal.

According to some embodiments, a method of sealing an exhaust pipe of a vehicle (e.g., an aircraft) includes sliding (e.g., radially or axially) a seal over the exhaust pipe. The seal can include a collar portion bounding an opening that is configured to receive the exhaust pipe therethrough. The seal can include a shroud portion connected to the collar portion and extending radially outward therefrom. The seal can include a valve connected to the collar portion and configured to facilitate selective fluid communication with an interior of the collar portion. The method can include installing portion of the vehicle, such as a tail cone, over a portion of the exhaust pipe. The method can include connecting the shroud portion of the seal to the portion of the vehicle, such as the tail cone. The method can include inflating the collar portion of the seal. The method can include forming, with the inflated collar portion, a generally fluid tight seal around exhaust pipe.

In some variants, the method includes deflating the collar portion before axially sliding the seal over the exhaust pipe. In some embodiments, deflating the collar portion comprises applying a vacuum to the interior of the collar portion. In certain embodiments, connecting the shroud portion of the seal to the tail cone comprises connecting a plurality of fasteners with corresponding apertures in the shroud portion. In some implementations, axially sliding the seal over the exhaust pipe comprises axially sliding the seal over the insulation on the exhaust pipe.

In some embodiments, a seal configured to seal around an exhaust pipe (e.g., of an aircraft auxiliary power unit) includes a resilient collar portion. The resilient collar portion can include a hollow space configured to receive a volume of fluid. The seal can include an opening bounded by the resilient collar portion. The opening can be configured to receive the exhaust pipe. The seal can include a shroud portion connected to the resilient collar portion and extending radially outward therefrom. The shroud can be configured to be secured with a portion of a vehicle, such as an aircraft tail cone, faring, or other portion. The resilient collar portion can be configured to contract (e.g., partially or fully collapse) in response to the application of a vacuum to the hollow space. In some implementations, when contracted, the opening has a diameter that is greater than a diameter of the exhaust pipe. The resilient collar portion can be configured to automatically resiliently return to a resting and/or non-contracted state in response to removal of the vacuum to the hollow space. In some embodiments, in the resting and/or non-contracted state, the opening has a diameter that is less than diameter of the exhaust pipe and the resilient collar sealingly engages around the exhaust pipe.

In some embodiments, the seal includes a valve configured to be fluidly coupled with a vacuum source. In some variants, coupling the seal (e.g., via the valve) with the vacuum source causes the resilient material of the collar portion to contract (e.g., radially). For example, the collar portion can deflect inward and/or reduce in volume. In some variants, decoupling the valve from the vacuum source causes the resilient material of the collar portion to expand, such as due to ambient air entering the collar portion. In some embodiments, the valve is a breather valve. In some embodiments, the resilient material is hollow. In certain embodiments, the collar portion has an oval-shaped cross-section when fully expanded. In some variants, the collar portion has a polygonal-shaped cross-section when fully expanded. In some implementations, the collar portion fully surrounds the opening through the seal. In some variants, the opening is oval-shaped or polygonal-shaped.

According to some embodiments, a method of sealing an exhaust pipe of an aircraft includes connecting a seal to a tail cone of the aircraft. The seal can include a collar portion of resilient material bounding an opening that is configured to receive the exhaust pipe therethrough. The collar portion can include a shroud portion connected to the collar portion and extending radially outward therefrom. The method can include fluidly coupling a vacuum source with the collar portion. The method can include contracting the collar portion. The method can include expanding a diameter of the opening to be larger than an outer diameter of the exhaust pipe. The method can include axially sliding the seal over the exhaust pipe. The method can include disconnecting the vacuum source from the valve. The method can include automatically expanding the resilient material of the collar portion to form a generally fluid-tight seal around the exhaust pipe.

### BRIEF DESCRIPTION OF THE DRAWINGS

Various features of the seals and methods disclosed herein are described below with reference to the drawings of certain embodiments. The illustrated embodiments are intended to illustrate, but not to limit the present disclosure.

FIG. 1 is a longitudinal cross-sectional view of an APU exhaust pipe extending out from a tail cone of an aircraft.

FIG. 2 is a perspective view of an embodiment of an exhaust pipe seal.

FIG. 3 is a front plan view of the seal of FIG. 2.

FIG. 4 is a side plan view of the seal of FIG. 2.

FIG. 5 is a cross-sectional view of the seal of FIG. 2 as viewed along the cut-plane 5-5 of FIG. 3.

FIG. 6 is a perspective view of an embodiment of an exhaust pipe seal having a polygonal shroud.

FIG. 7 is a side plan view of an embodiment of an exhaust pipe seal installed on a portion of an exhaust pipe.

FIG. 8 is a front plan view of the seal and pipe of FIG. 7.

FIG. 9 is a perspective view of the seal and pipe of FIG. 7.

FIG. 10 is a longitudinal cross-sectional view of a pipe and seal, wherein the seal is deflated.

FIG. 11 is a longitudinal cross-sectional view of the pipe and seal of FIG. 10, wherein the seal is deflated and the tail cone is installed over the pipe.

FIG. 12 is a longitudinal cross-sectional view of the pipe and seal of FIG. 10, wherein the seal is inflated and the tail cone is installed.

FIG. 13 is a front plan view of another embodiment of an exhaust pipe seal.

FIG. 14A is a cross-section taken along the line 14-14 of FIG. 13, wherein the seal is in an expanded and/or inflated configuration.

FIG. 14B is a cross-section taken along the line 14-14 of FIG. 13, wherein the seal is in a contracted and/or deflated configuration.

FIG. 15 is a longitudinal cross-sectional view of a pipe and seal, wherein the seal is in an expanded and/or inflated configuration and installed in a tail cone.

FIG. 16 is a longitudinal cross-sectional view of the pipe and seal of FIG. 15, wherein the seal is in a contracted and/or deflated configuration.

FIG. 17 is a longitudinal cross-sectional view of the pipe and seal of FIG. 15, wherein the seal is expanded and/or inflated and installed over the pipe.

### DETAILED DESCRIPTION OF CERTAIN EMBODIMENTS

Various embodiments of a seal and related methods are disclosed. Certain embodiments of the seal are disclosed in the context of an APU exhaust system in the tail cone of an aircraft, as the seal has particular utility in that context. However, the various aspects of the present disclosure can be used in many other contexts as well, such as exhaust pipes that extend through other portions of an aircraft, automobile, or watercraft. None of the features described herein are essential or indispensable. Any feature, structure, or step disclosed herein can be replaced with or combined with any other feature, structure, or step disclosed herein, or omitted. While certain materials and material properties are described herein with respect to the constructions of the disclosed seals, other material types and properties may be utilized. As explained in detail below, the seal can take many shapes and sizes, both with respect to the opening of the seal and the cross-sectional shape of the bulb of the seal.

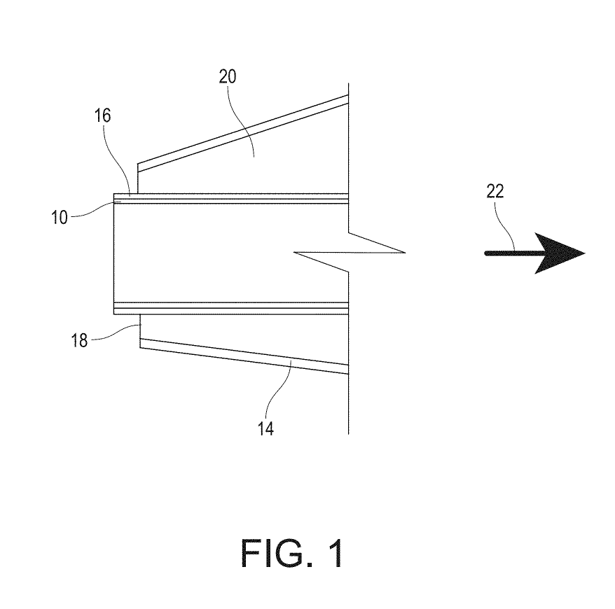

FIG. 1 illustrates an exhaust pipe 10 (e.g., an APU exhaust pipe). The pipe 10 can extend out from a tail cone 14 or from some other structure of an aircraft. Because of hot gases passing through the exhaust pipe 10, the exhaust pipe 10 can become quite hot. For example, the exhaust pipe 10 can reach a temperature of at least about 1,000° F. To protect the tail cone 14 and other portions of the aircraft from such heat, all or a portion of the pipe 10 is typically wrapped with one or more layers of insulation 16.

In many applications, there is a gap 18 between the pipe 10 and the inside of the tail cone 14. The gap 18 may be presented around the entire perimeter of the pipe 10 or only at certain portions about the perimeter of the pipe 10. As illustrated, the insulation may not occupy the entire gap 18. In some scenarios, exhaust from the pipe 10 or other unwanted material can pass into a space 20 between the pipe 10 and the tail cone 14 via the gap 18. For example, as the aircraft travels in the direction of travel 22, a low-pressure region can develop at and near the gap 18 between the pipe 10 and the tail cone 14. The low-pressure region can entrain debris, exhaust (e.g., exhaust from the engines of the aircraft), and other substances into the aircraft via the gap 18.

To reduce the likelihood of entry of exhaust, debris, and other undesired environmental hazards into the tail cone 14 of the aircraft, a seal 30 may be positioned around the pipe 10 and/or within the tail cone 14. The seal 30 can be configured to inhibit or prevent passage of debris, exhaust, pollutants, and/or other undesirable substances from entering the aircraft via the gap 18. Such sealing can inhibit or prevent exhaust pollutants from entering the aircraft cabin, can increase passenger/pilot comfort, and/or can reduce the chance of damage to exhaust pipe 10, tail cone 14, insulation 18, and/or other components of the aircraft. In some cases, the seal 30 can help to reduce wear on components within the tail cone 14 or elsewhere within the aircraft.

Preferably, the seal 30 can be configured to be installed on the pipe 10 without damaging the pipe 10, insulation 16, and/or tail cone 14. In some embodiments, the seal 30 is designed to enable a change in size, such as being inflatable, deflatable, or otherwise capable of transition between a plurality of sizes or shapes in order to facilitate installation of the seal 30 on the pipe 10 and/or sealing against the pipe 10.

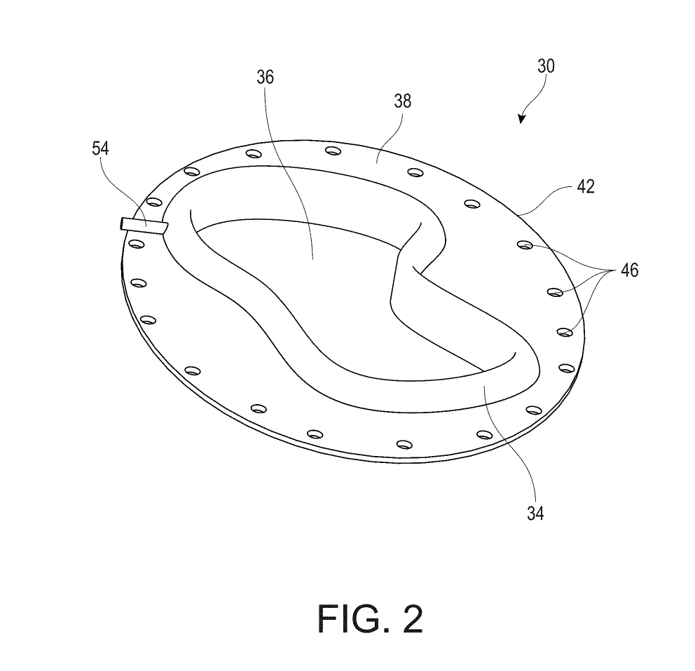

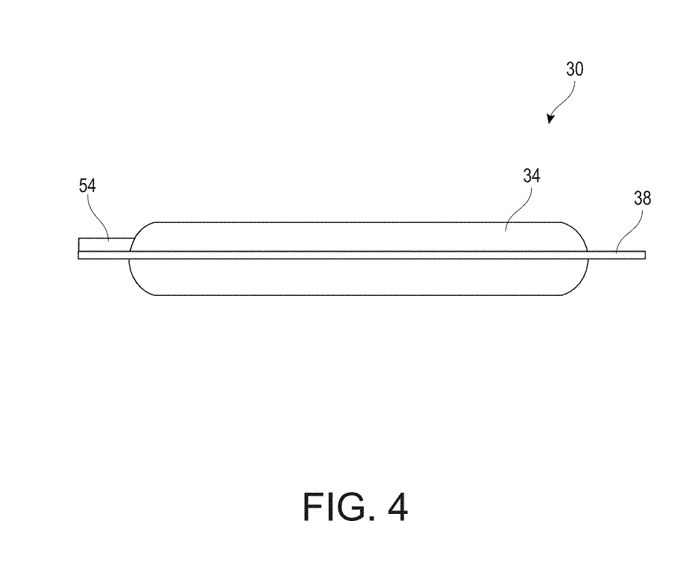

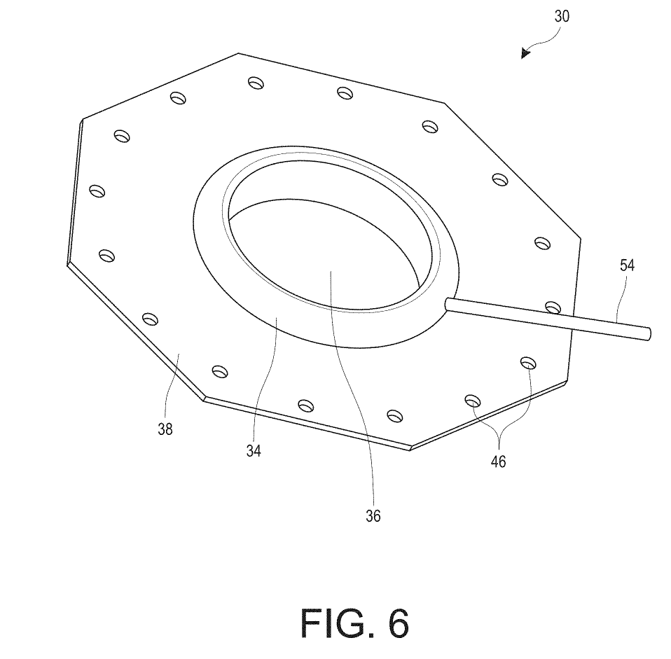

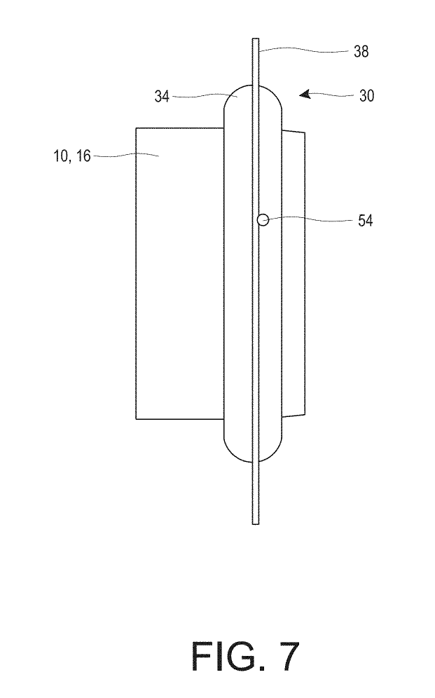

An example of a seal 30 is illustrated in FIGS. 2-5. Another example of the seal 30 is illustrated in FIG. 6. A further example of the seal 30 is illustrated in FIGS. 7-9. The seal 30 can be constructed from a material able to withstand high temperatures and/or high pressure environments. For example, the seal 30 can be constructed from a material able to withstand temperature ranges between at least about −65° F. and/or less than or equal to about 1000° F. Some embodiments of the seal 30 comprise a reinforced silicone material (e.g., glass-reinforced silicone). Various embodiments are configured to withstand high temperatures, such as at least about 900° F. Some implementations comprise fiberglass reinforced silicone or fiber-reinforced polymer. Certain embodiments of the seal 30 comprise aramid fibers. Some embodiments of the seal 30 comprise para-aramid synthetic fibers.

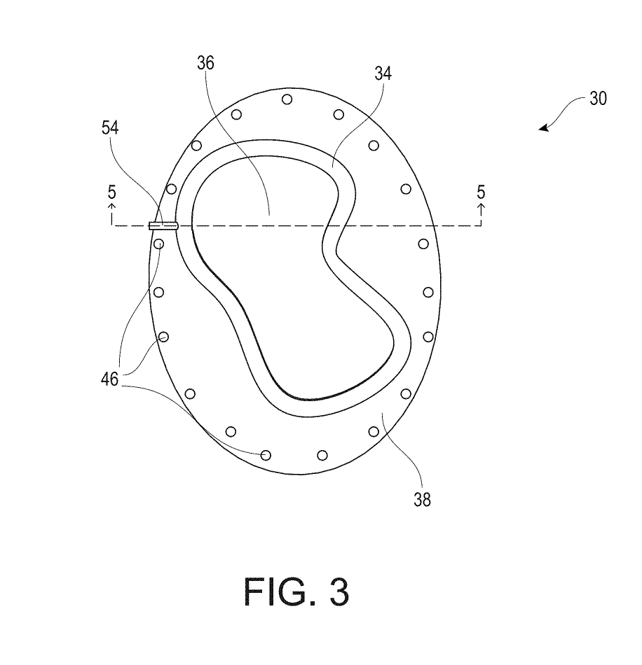

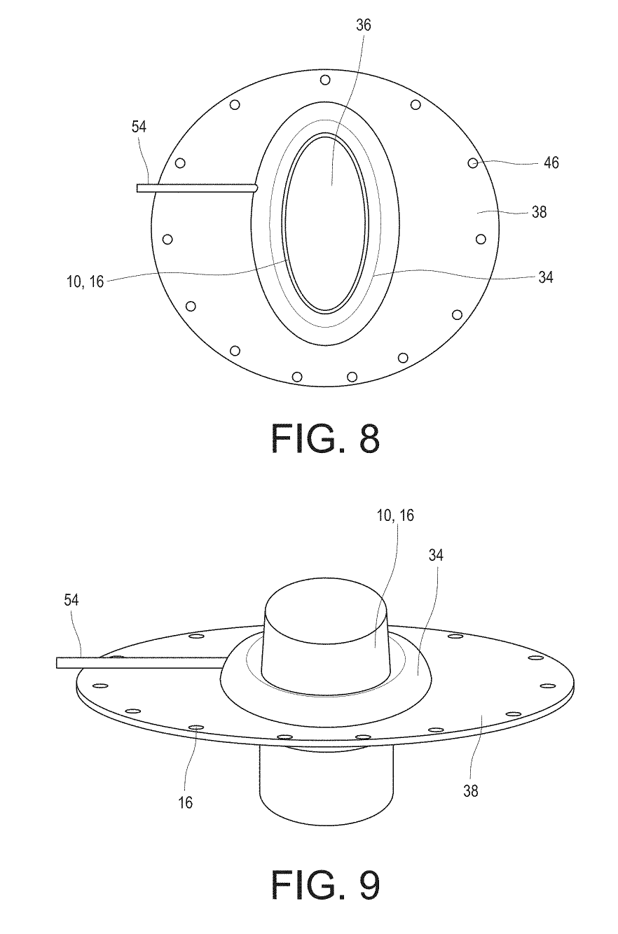

The seal 30 can have various shapes. For example, as shown in FIG. 3, an outer periphery of the seal 30 can be generally elliptical. As illustrated in FIG. 6, the outer periphery of the seal 30 can be generally hexagonal or octagonal. As shown in FIG. 8, an outer periphery of the seal 30 can be generally circular. In certain variants, the outer periphery of the seal 30 has other shapes, such as rectangular, diamond shaped, irregular, or otherwise.

The seal 30 can include a collar portion 34. The collar portion 34 can surround an opening 36 through a portion of the seal 30. The collar portion 34 can be configured to fit around the pipe 10 when installed. The seal 30 can include a shroud portion 38. The shroud portion 38 can surround all or a portion of the collar portion 34. As illustrated, the shroud portion 38 can extend radially outward from the collar portion 34 (e.g., in a direction away from the opening 36).

The shape of the opening 36 can be selected to accommodate a given exhaust pipe cross-section. For example, when a cylindrical pipe 10 is to be sealed, the opening 36 can have a generally circular shape (see FIG. 6). When an oval-shaped pipe 10 is to be sealed, the opening 36 can have an oval shape, such as an oval shape sized and proportioned to accommodate the oval shape of the pipe 10 (see FIGS. 7-9). Polygonal shapes and combinations of polygonal and curved shapes may be utilized for the opening 36. As shown in FIG. 3, in some embodiments, the opening 36 has an irregular shape. In some embodiments, the seal 30 can be generally “O” shaped. In some variants, the seal 30 is generally “C” shaped.

In some cases, an outer perimeter 42 of the shroud portion 38 can be sized and/or shaped to engage with the tail cone 14 or other attachment structure. For example, the shroud portion 38 may be sized and shaped such that attachment structures in the tail cone 14, or other portion of the aircraft, can engage with the shroud portion 38 such as around the perimeter of the shroud 38. In some embodiments, the seal 30 and/or the shroud 38 is configured to fill substantially an entirety of a cross-section of the tail cone 14 between the collar portion 34 and the pipe 10. In some embodiments, the shroud 38 extends radially outward a sufficient distance to span the gap 18. In certain implementations, the shroud 38 has a shape that corresponds to the interior of the tail cone 14, such as a generally polygonal shape (see FIG. 6), generally curved shape (see FIGS. 2, 3, 8, and 9), some combination thereof, or otherwise.

In some embodiments, the shroud 38 includes one or more features configured to facilitate connecting the seal 30 with the tail cone 14. For example, the shroud 38 can include one or more apertures 46. The apertures 46 can be configured to receive a fastener (e.g., a bolt, screw, rivet, nail, or other fastener), protrusion, or other structure of the tail cone 14. In some embodiments, the shroud 38 may include one or more lips, indentations, or other engagement structures configured to engage a portion of the tail cone 14.

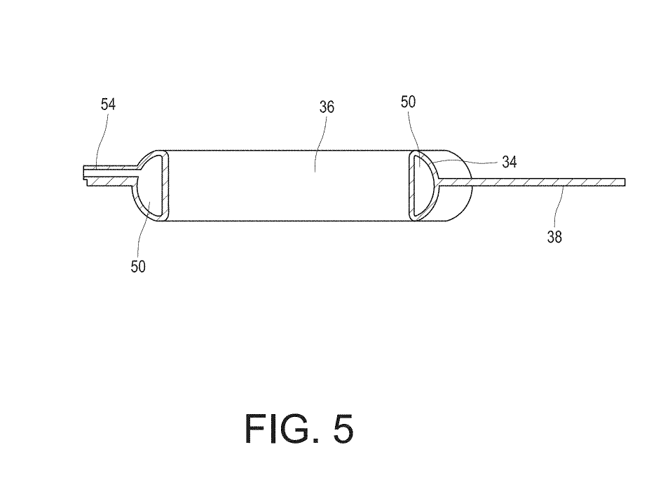

As illustrated in FIG. 5, the collar portion 34 of the seal 30 can comprise a hollow cavity 50. In some embodiments, the collar portion 34 is hollow around an entire perimeter of the opening 36. In some embodiments, the collar portion 34 is hollow around a portion of the perimeter of the opening 36 and solid over a portion of the perimeter of the opening 36. The size and/or shape of the hollow cavity 50 within the collar portion 34 can be generally uniform throughout the collar portion 34. In some cases, the shape and/or size of the hollow cavity 50 is non-uniform around the perimeter of the opening 36. In some implementations, the cavity 50 comprises a support, such as a foam, ribs, or otherwise. In various embodiments, the cavity 50 can be readily contractible, such as in response to a vacuum being applied to the cavity 50. In some implementations, the cavity 50 is resilient, such as resiliently configured to return to an inflated state (such as is shown in FIG. 5). The hollow cavity 50 can be configured to receive a fluid, such as air. The cavity 50 can be inflatable and/or deflatable.

In the illustrated embodiment of FIG. 5, the collar portion 34 has a generally D-shaped cross-section with the flat side of the “D” forming the perimeter of the opening 36. In some embodiments, the “D” shape is reversed over at least a portion of the collar portion 34 such that the curved portion of the “D” forms at least a portion of the perimeter of the opening 36. Other shapes, such as circular (e.g., generally O-shape), polygonal, oval shape (see FIGS. 7-9), and/or some combination thereof can be utilized for at least a portion of the collar portion 34. As illustrated in FIG. 5, the shape of the cross-section of the hollow cavity 50 can generally match the cross-sectional shape of the collar portion 34. In some embodiments, all or a portion of the hollow cavity 50 has a cross-sectional shape that is different from the cross-sectional shape of the collar portion 34.

The seal 30 can include an outlet structure configured to facilitate fluid communication between the hollow cavity 50 of the collar portion 34 and the ambient environment and/or a fluid transfer device (e.g., a pump or vacuum source). In some embodiments, the outlet structure is a valve 54 (e.g., a Schrader valve or other appropriate valve). The valve 54 can be a one-way valve. The valve 54 can be a normally-closed valve, such as a valve that is configured to remain closed unless a user intentionally opens the valve 54. In some embodiments, the valve is a two-way valve.

The valve 54 can facilitate selective inflation and/or deflation of the collar portion 34 of the seal 30. Inflating the collar portion 34 can reduce the size of the opening 36 and/or tighten the collar portion 34 onto the pipe 10 and/or insulation 16. Deflating the collar portion 34 can increase the size of the opening 36 and/or loosen the collar portion 34 from the pipe 10 and/or insulation 16. In some implementations, deflating the valve is performed with a vacuum. In some embodiments, the seal 30 includes a valve extension (not shown) configured to facilitate operation of the valve 54 from outside of the tail cone 14. The valve extension can comprise a tube that extends from the valve to outside and/or near the outside of the tail cone 14.

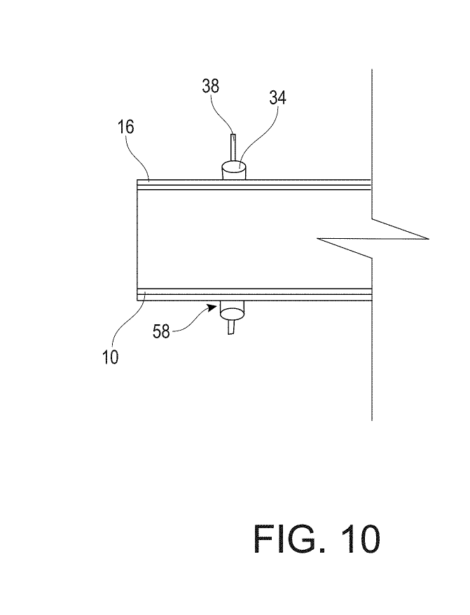

FIGS. 10-12 illustrate a method of installing the seal 30 onto an exhaust pipe 10 of an APU. Prior to installing the seal 30, some embodiments of the method include removing the tail cone 14 or other aircraft structure surrounding the pipe 10.

In some embodiments, the method includes deflating the collar portion 34. The deflating can occur prior to fitting the seal 30 around the pipe 10. Deflating the collar portion 34 can loosen the fit between the outside of the pipe 10 and/or insulation 16 and the collar portion 34. This can reduce the likelihood of damage to the pipe 10 or insulation 16 as the seal 30 is passed over the pipe. In some embodiments, a gap 58 is present between the collar portion 34 and the pipe/insulation 10, 16 when the collar portion 34 is deflated. In some embodiments, deflating the seal 30 is performed with a vacuum, such as by connecting the valve 54 to a vacuum source, thereby evacuating some or all of the fluid from the cavity 50 and/or contracting the collar portion 34.

The method can include positioning the seal 30 on and/or around the pipe 10 and/or insulation 16. As illustrated, the pipe 10 can extend through the opening 36 of the seal 30. The seal 30 can be positioned around the pipe 10 and/or insulation 16 such that the pipe 10 extends through the opening 36 of the seal 30. In various embodiments, positioning the seal 30 includes axially sliding the seal 30 over the pipe 10 and/or insulation 16. In some variants, the seal 30 is radially slid onto the pipe 10, such as through a circumferential gap in the seal 30. The seal 30 can be positioned in a location within the tail cone 14 (when installed). The method can include positioning the seal 30 in an axial location such that the shroud 38 can engage with the interior of the tail cone 14. In some embodiments, the method includes axially sliding the seal 30 along the pipe 10 a distance along that is greater than or equal to the diameter of the opening 36. The method can include axially aligning the seal 30 with corresponding securing features on the tail cone 14, such as flanges. The seal 30 can be secured to the securing features, such as the bolts.

The method can include inflating the collar portion 34. In some embodiments, the collar portion 34 is inflated before the tail cone 14 is attached to the aircraft. In certain variants, the collar portion 34 is inflated after the tail cone 14 is attached to the aircraft. Inflating the collar portion 34 can be performed with a fluid source, such as with an air compressor. In some implementations, inflating the collar portion 34 comprises opening the valve 54. Certain variants include allowing ambient air to flow into the collar portion 34. Some embodiments inflate the collar portion by removing a vacuum from fluid connection with the cavity 50. The collar portion 34 can be inflated sufficiently to provide a generally fluid-tight seal around the pipe 10 and/or insulation 16. In some embodiments, the collar portion 34 is inflated to a certain sealing pressure against the pipe 10 and/or insulation 16, such as at least about 10 psi. In some embodiments, the collar portion 34 is inflated to a sealing pressure greater than or equal to about 3 psi and/or less than or equal to about 20 psi.

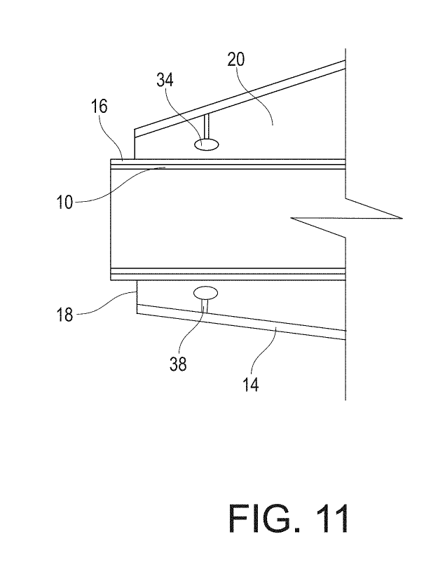

As shown in FIG. 11, the method can include positioning the tail cone 14 over the seal 30 installed on the pipe 10. For example, the tail cone 14 can be axially slid over the seal 30 and an end of the pipe 10. The method can include engaging the seal 30 with the tail pipe 14, such as the shroud portion 38 with the tail cone 14. In some embodiments, the method includes connecting the apertures 46 of the shroud 38 with the tail cone 14, such as with fasteners, protrusions on the tail cone 14, or otherwise. In certain embodiments, the shroud 38 can be compressed by or otherwise attached to the tail cone 14 when the tail cone 14 is attached to the aircraft. In some embodiments, the tail cone 14 or some other portion of the aircraft can include one or more inwardly extending flanges (not shown) used to compress or otherwise connect to the shroud portion 38.

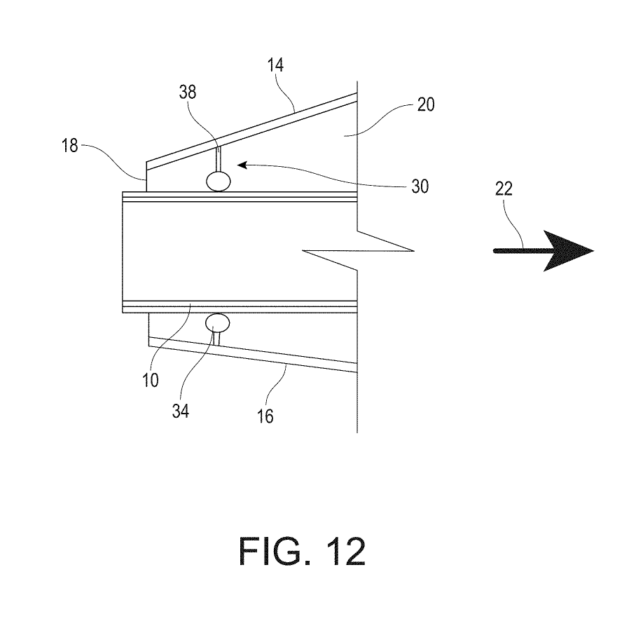

As illustrated in FIG. 12, when the collar portion 34 is inflated and the shroud portion 38 is attached to the tail cone 14, the seal 30 occupies and/or seals the space 20 between the pipe 10 and the tail cone 14 from the ambient environment. This sealing can inhibit or prevent ingress of gases, debris, and/or other undesirable materials into the aircraft via the tail cone 14. Such ingress inhibition and/or prevention is especially desired when the aircraft is travelling in the direction of travel 22 due to the formation of a low-pressure region in the vicinity of the opening in the tail cone 14 through which the pipe 10 extends.

Some embodiments include removing the seal 30, such as for replacement or repair. For example, some methods include deflating the collar portion 34, such as with a vacuum. The method can include removing the tail cone 14. The method can include disconnecting the seal 30 from the tail cone 14, such as by removing fasteners from the apertures 46 of the seal 30. The deflation of the collar portion 34 can be performed prior to or after removal of the tail cone 14. The deflation of the seal 30 can increase the diameter of the opening 36, which can enable the seal 30 to be readily removed from the pipe 10. After removal, the method can include installing a seal 30, as discussed above.

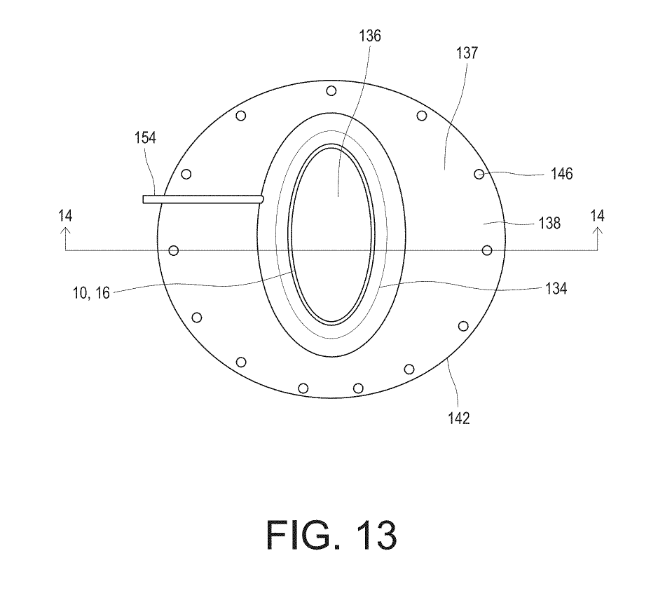

FIG. 13 illustrates an exhaust pipe seal 130 for engaging with the exhaust pipe 10. The seal 130 can be structured and used in a similar manner to the exhaust pipe seal 30 described above, with some of the differences and similarities noted below. The seal 130 can include any of the features of the seal 30. The seal 130 can include a collar portion 134 and/or a shroud 138. The seal 130 can be shaped to fit within the tail cone 14 and/or over the exhaust pipe 10. For example, the seal 130 can have an outer perimeter 142 of any shape including polygonal, hexagonal, elliptical, circular, or any other suitable shape. The outer perimeter 142 can generally match the geometry of at least portions of the tail cone 14. An opening 136 through the seal 130 can receive the exhaust pipe 10. In some implementations, the opening 136 is in the radial and/or axial center of the seal 130. The opening 136 can be shaped to at least partially match the profile of the exhaust pipe 10. The outer diameter of the exhaust pipe 10 can include the insulation 16 that covers a portion of the exhaust pipe 10.

Similar to the seal 30, the seal 130 can be constructed of a material that can be subjected to high and low temperature extremes and/or high and low pressure environments. For example, in some embodiments, the seal 130 is made of glass-reinforced silicon material. In various embodiments, the seal 130 is configured to directly contact the insulation 16 and/or the pipe 10. The seal 130 can be configured for use at high temperatures (e.g., at least about 1,000° F.) and/or low temperatures (e.g., less than or equal to about −65° F.). In some implementations, the seal 130 comprises fiberglass reinforced silicone or fiber-reinforced polymer. Certain embodiments of the seal 130 comprise aramid fibers. Some embodiments of the seal 130 comprise para-aramid synthetic fibers.

The seal 130 can function in a manner similar to the seal 30. Specifically the seal 130 can be used to prevent the entrainment of debris or exhaust gases from entering into the fuselage of an airplane such as through the gap 18 between tail cone 14 and the exhaust pipe 10 (e.g., into the space 20). In some implementations, the outer perimeter 142 of the seal 130 can engage within the tail cone 14 and the exhaust pipe 10 can fit within the opening 136. The seal 130 can thus span the gap 18 and prevent or substantially prevent entrainment of debris and gases.

The collar portion 134 of the seal 130 can facilitate the assembly of the seal 130 with the exhaust pipe 10. The collar portion 134 can be coupled with the shroud 138 and formed at least partially around the opening 136. In some implementations, the collar portion surrounds around the opening 136 and/or the exhaust pipe 10. The collar portion 134 can be structured so that it sealingly engages with the pipe 10 (and/or the insulation 16).

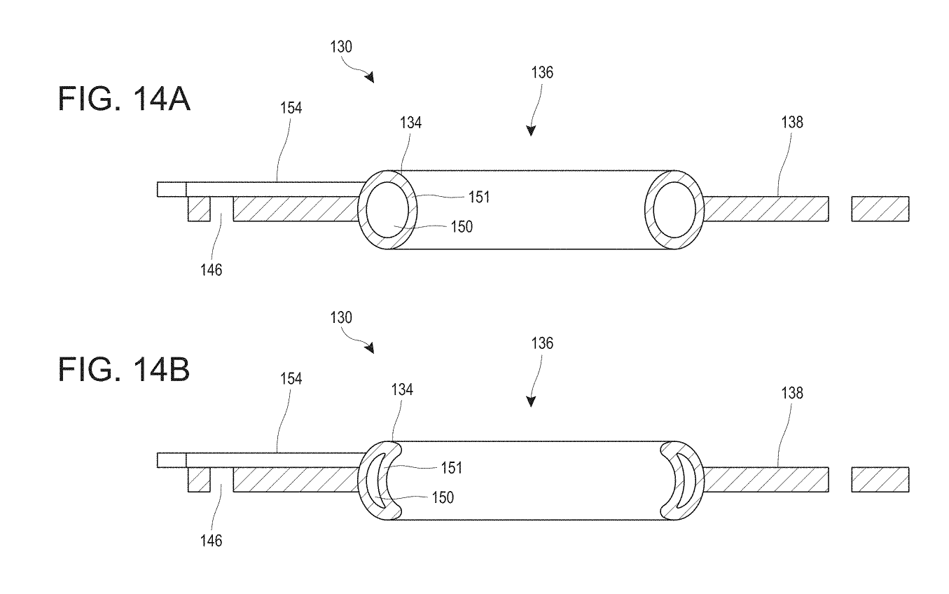

In some embodiments, the collar portion 134 can include a resilient structure 151. As shown in FIGS. 14A and 14B, the resilient structure 151 can include a hollow space 150 disposed therein. The collar portion 134 can be shaped in the form of an elongate tube. A cross-sectional profile of the tube can be circular, substantially or partially circular, elliptical, bulb-shaped, or D-shaped; however, the cross-sectional profile is not limited to these shapes. Any shape of the resilient structure 151 that sealingly engages with the pipe 10 can be suitable. The resilient structure 151 can be of a material that can be subjected to high and low temperature extremes and/or high and low pressure environments, such as glass-reinforced silicon material. In some embodiments, the resilient structure 151 is manufactured from an elastomeric material. The resilient structure 151 can have a nominal size and profile that is designed into the part (e.g., onto the pipe and inside the tail cone). Through proper tooling and analysis, this profile can be designed to mimic the percentage of compression as well as the net compressed shape of the opening in the as-installed condition. Further design consideration will result in varying the thickness or properties of the seal materials to increase or decrease desirable attributes like compression/rebound rate, static compression, temperature resistance or a specific cross section in any of the 3 states (expanded, normal, or contracted) as needed to contact or clear a detail in the installation. In some embodiments, the collar portion 134 is biased to return to an inflated and/or original and/or resting state, such as due to the bias provided by the resilient structure 151. In some implementations, the material of the resilient structure 151 is configured to provide the biasing force. In some variants, the resilient structure 151 includes biasing members, such as embedded braces or fibers, that provide the biasing force.

The resilient structure 151 can be sufficiently stiff and/or elastic to maintain and/or return to the shape of the cross-sectional profile. In some implementations, the resilient structure 151 can maintain the shape of, and/or return to a given shape, of the collar portion 134. When a force is exerted against the collar portion 134, the resilient structure 151 can provide a reactive force tending to return the collar portion to its original and/or non-deflated shape. For example, the reactive force can tend to return the resilient structure 151 to substantially its shape before the application of the vacuum. In some implementations, the reactive force tends to expand the resilient structure 151 toward substantially a shape that substantially maximizes the volume of the hollow space 150. In some implementations, the reactive force can provide a sealing force against the exhaust pipe 10. In some implementations of the seal 130, the collar portion 134 is not inflated when installed to sealingly engage with the exhaust pipe 10 and/or does not rely on a higher than ambient pressure within the hollow space 150 to inflate the collar portion 134. In some embodiments, the resilient structure 151 is sufficiently resilient/elastic to produce a sealing engagement with the pressure the hollow space 50 being substantially equal to ambient pressure. For example, the hollow space 150 can have substantially the same pressure as an atmosphere surrounding the collar portion 134.

The seal 130 can provide several benefits. For example, because the collar portion 134 engages resiliently to seal against the pipe 10 at ambient pressure, a higher pressure within the seal 130 need not be maintained in order to maintain the seal with the pipe 10. Thus, in some embodiments, even were the hollow space 150 to be breached or otherwise damaged during use, a seal with the pipe 10 can be maintained.

The shroud 138 can be structured similar to the shroud 38 described above. The shroud 138 can function to fill the gap 18 between the tail cone 14 and the pipe 10 and/or insulation 16. The shroud 138 can provide support and structure for the collar portion 134. The shroud 138 can also couple the seal 130 with the tail cone 14.

As shown in FIG. 13, the shroud 138 can include a planar portion 137 between the outer perimeter 142 and the opening 136. In some implementations, the planar portion 137 is substantially planar. In other implementations, the planar portion 137 includes contouring such as reinforcing ribs, vents, or other structural elements. As described above, the shape of the planar portion 137 and the outer perimeter 142 can fit within the tail cone 14.

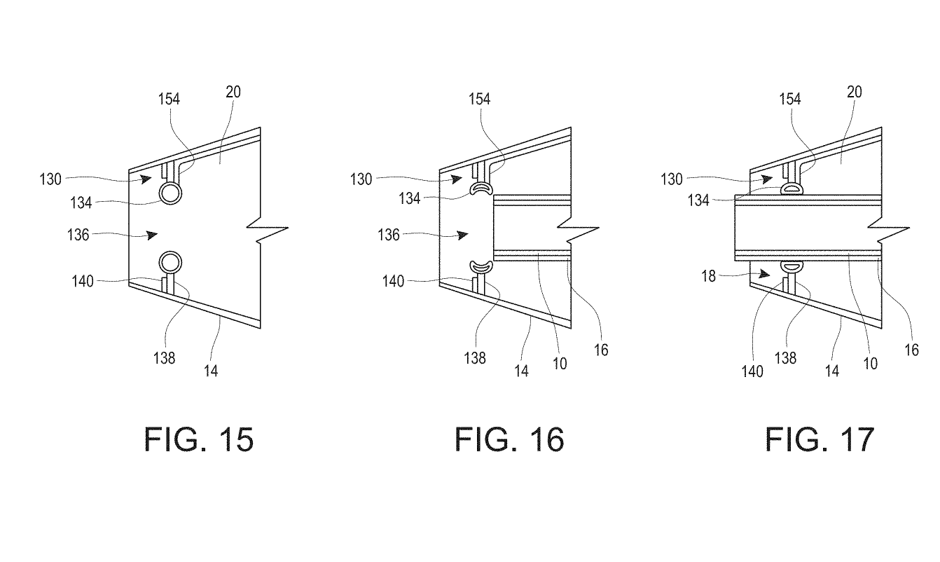

The shroud 138 can include a plurality of apertures 146. Like the apertures 46, the apertures 146 can be used to couple the seal 130 with the tail cone 14. In some implementations, the tail cone 14 can include a flange 140 disposed therein, as illustrated in (FIGS. 15-17). The flange 140 can also include a plurality of connecting mechanisms such as, but not limited to, holes, bolts, screws, and the like, to couple with the shroud 138 (e.g., by the plurality of flanges 146). In this manner, the seal 130 can be coupled within the tail cone 14.

The seal 130 can include a valve 154. The valve 154 can connect the hollow space 150 with a fluid sink or source, such as with a vacuum source for contracting the collar portion 134. The contracted resilient structure 151 can be radially reduced in size in the compressed configuration. In some implementations, the resilient structure 151 can be compressed into a generally crescent shape, as illustrated in FIG. 14B, although the resilient structure 151 is not limited to this contracted shape. The term “contract” is a broad term with its plain and ordinary meaning and can include, for example, a portion of the resilient structure 151 being convex in shape, as is illustrated in FIG. 14B. As also shown in the non-limiting example of FIG. 14B, in the contracted state, the resilient structure 151 can include some volume in the hollow space 150. In some implementations, between the non-contracted and the contracted state, the volume of the hollow space 150 is reduced by at least about: 25%, 50%, 75%, 90%, 99%, values between the aforementioned values, or other values.

The valve 154 can be a two-way valve. For example, the valve 154 can be a breather valve that allows for the flow of fluid both into and out of the hollow space 150. Instead of stopping fluid flow in one direction or another, the valve 154 can merely inhibit or slow this flow of fluid into and out of the collar portion 134. This can provide flexibility to the amount of pressure within the hollow space 150. For example, the valve 154 can allow fluid to automatically enter or exit from the seal 130 in response to changes in temperature and/or pressure. This can reduce the chance of damage to the seal 130 and/or can extend to operating range (e.g., in terms of altitude) of the seal 130. The valve 154 can also prevent objects from entraining within the hollowed space 150.

In some implementations, the inner diameter of the opening 136 is smaller than the diameter of the exhaust pipe 10. A vacuum source can be coupled with the collar portion 134 (e.g., through the valve 154). The vacuum source can contract the collar portion 134 by reducing the pressure within the hollow space 150. The contracting resilient structure 151 can allow for the seal 130 to be installed on the exhaust pipe 10 (e.g., by sliding over one end) with exhaust pipe 10 within the opening 136. The vacuum source can then be released and the hollow space 150 of the collar portion 134 can return to normal (e.g., ambient) pressure. The collar portion 134 can return to shape and/or create a sealing force that engages with the exhaust pipe due to the resilient structure 151 of the collar portion 134. In some installations, the tail cone 14 installed after the seal 130 is installed over the exhaust pipe 10. In certain implementations, the collar portion 134 can be inflated, similar to the seal 30.

In some embodiments, the hollow space 150 dynamically adapts to changes in the environment. In some variants, when the seal 130 is subjected to high or low temperatures (e.g., from the tail pipe and/or from atmospheric conditions), and/or high or low pressure (e.g., from atmospheric pressure at sea level to 30,000 feet above sea level) the collar portion 134 can react in an uninhibited manner, such as by venting through the valve 154. In various embodiments, the seal 130 is maintained at ambient pressure. In several embodiments, the seal 130 operates independently of other aircraft systems. For example, the seal 130 does not require than an engine be operating on the aircraft, such as to provide pressurized air. The seal 130 can maintain the seal with the pipe 10 even when the aircraft is not operating.

In certain embodiments, the seal 130 can reduce assembly complexity and time. For example, the seal 130 can be installed separately on the tail cone 14. This facilitates installation of the seal 130 and tail cone 14 with the rest of the fuselage of the airplane because the seal 130 can be attached to the tail cone 14 before it is installed on the fuselage. The seal 130 can be contracted (e.g., by attaching the vacuum source) and slid over the exhaust pipe 10. This can greatly decrease the amount of assembly and disassembly time needed to install the seal 130. In some installations, the seal 130 does not need to be removed from the tail cone 14 during routine maintenance and inspections.

A method of installation for the seal 130 is illustrated in FIGS. 15-17. In some implementations, the seal 130 can be installed into the tail cone 14, as shown in FIG. 15. For example, a plurality of mechanical fasteners (e.g., bolts fitted through the apertures 146) can be used to couple the shroud 138 with the flange 140 within the tail cone 14.

The collar portion 134 can be contracted by the application of the vacuum source, as shown in FIG. 16. For example a vacuum source can be fluidly coupled (e.g., by a hose) to the valve 154. The diameter of the opening 136 can be increased by contracting collar portion 134. The tail cone portion 14 can be installed on the fuselage, as shown in FIG. 17. The exhaust pipe 10 can be fit within the opening 136, the seal 130 being slid over the end of the pipe 10. When the tail cone is in place and/or the seal 130 is in place on the exhaust pipe 10, the vacuum source can be removed, shut off, or fluidly decoupled. The collar portion can resiliently at least partially re-expand, thereby to sealingly engaging with the exhaust pipe 10.

### Certain Terminology

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

Several illustrative embodiments of seals and methods of installation and use have been disclosed. Although this disclosure has been described in terms of certain illustrative embodiments and uses, other embodiments and other uses, including embodiments and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various embodiments. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one embodiment or example in this disclosure can be combined or used with (or instead of) any other portion of any of the steps, processes, structures, and/or devices disclosed or illustrated in a different embodiment, flowchart, or example. The embodiments and examples described herein are not intended to be discrete and separate from each other. Combinations, variations, and other implementations of the disclosed features are within the scope of this disclosure.

Some embodiments have been described in connection with the accompanying drawings. While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in other implementations. Also, the separation of various components in the implementations described above should not be understood as requiring such separation in all implementations, and it should be understood that the described components and systems can generally be integrated together in a single product or packaged into multiple products. Additionally, other implementations are within the scope of this disclosure.

Further, while illustrative embodiments have been described, any embodiments having equivalent elements, modifications, omissions, and/or combinations are also within the scope of this disclosure. Moreover, although certain aspects, advantages, and novel features are described herein, not necessarily all such advantages may be achieved in accordance with any particular embodiment. For example, some embodiments within the scope of this disclosure achieve one advantage, or a group of advantages, as taught herein without necessarily achieving other advantages taught or suggested herein. Further, some embodiments may achieve different advantages than those taught or suggested herein.

Any of the seal features, structures, steps, or processes disclosed in this specification can be included in any embodiment. For example, the illustrated polygonal shroud perimeter may be used in combination with a round opening, an oval-shaped opening, and/or any other shaped opening.

Some embodiments have been described in connection with the accompanying figures. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

For purposes of summarizing the disclosure, certain aspects, advantages and features of the inventions have been described herein. It is to be understood that not necessarily any or all such advantages are achieved in accordance with any particular embodiment of the inventions disclosed herein. No aspects of this disclosure are essential or indispensable. In many embodiments, the seal may be configured differently than illustrated in the figures or description herein. For example, various functionalities provided by the illustrated modules can be combined, rearranged, added, or deleted. In some embodiments, additional or different processors or modules may perform some or all of the functionalities described with reference to the example embodiment described and illustrated in the figures. Many implementation variations are possible.

In summary, various embodiments and examples of seals and methods of installing and using the same have been disclosed. This disclosure extends beyond the specifically disclosed embodiments and examples to other alternative embodiments and/or other uses of the embodiments, as well as to certain modifications and equivalents thereof. Moreover, this disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims.

The following is claimed:

1. A seal configured to seal around an exhaust pipe of an aircraft auxiliary power unit, the seal comprising:
a collar portion bounding an opening, the opening configured to receive the exhaust pipe;
a shroud portion connected to the collar portion and extending radially outward therefrom; and
a valve connected to the collar portion and configured to facilitate selective fluid communication with an interior of the collar portion;
wherein the collar portion is inflatable to engage with an outer diameter of the exhaust pipe.

2. The seal of claim 1, wherein the collar portion is hollow.

3. The seal of claim 1, wherein the valve is a Schrader valve.

4. The seal of claim 1, wherein the collar portion has a D-shaped cross-section.

5. The seal of claim 1, wherein the collar portion has an oval-shaped cross-section.

6. The seal of claim 1, wherein the opening extends through the seal.

7. The seal of claim 6, wherein the opening is oval-shaped.

8. The seal of claim 6, wherein the opening is polygonal-shaped.

9. A method of sealing an exhaust pipe of an aircraft, the method comprising:
axially sliding a seal over the exhaust pipe, the seal comprising:
a collar portion bounding an opening that is configured to receive the exhaust pipe therethrough;
a shroud portion connected to the collar portion and extending radially outward therefrom; and
a valve connected to the collar portion and configured to facilitate selective fluid communication with an interior of the collar portion;
installing a tail cone over a portion of the exhaust pipe;
connecting the shroud portion of the seal to the tail cone;
inflating the collar portion of the seal; and
forming, with the inflated collar portion, a generally fluid tight seal around exhaust pipe.

10. The method of claim 9, further comprising deflating the collar portion before axially sliding the seal over the exhaust pipe.

11. The method of claim 10, wherein deflating the collar portion comprises applying a vacuum to the interior of the collar portion.

12. The method of claim 9, wherein connecting the shroud portion of the seal to the tail cone comprises connecting a plurality of fasteners with corresponding apertures in the shroud portion.

13. The method of claim 9, wherein axially sliding the seal over the exhaust pipe comprises axially sliding the seal over the insulation on the exhaust pipe.

14. A seal configured to seal around an exhaust pipe of an aircraft auxiliary power unit, the seal comprising:
a resilient collar portion comprising a hollow space configured to receive a volume of fluid;
an opening bounded by the resilient collar portion, the opening configured to receive the exhaust pipe; and
a shroud portion connected to the resilient collar portion and extending radially outward therefrom, the shroud configured to be secured with a tail cone of the aircraft;
wherein the resilient collar portion is configured to contract in response to the application of a vacuum to the hollow space, wherein when the resilient collar portion is contracted the opening has a diameter that is greater than a diameter of the exhaust pipe; and
wherein the resilient collar portion is configured to automatically resiliently return to a non-contracted state in response to removal of the vacuum to the hollow space, wherein when the resilient collar portion is in the non-contracted state the opening has a diameter that is less than diameter of the exhaust pipe and the resilient collar portion sealingly engages around the exhaust pipe.

15. The seal of claim 14, further comprising a valve configured to be fluidly coupled with a vacuum source, wherein the coupling with the vacuum source contracts the resilient material of the collar portion.

16. The seal of claim 15, wherein decoupling the valve from the vacuum source allows expansion of the resilient material of the collar portion.

17. The seal of claim 15, wherein the valve is a breather valve.

18. The seal of claim 14, wherein the resilient material is hollow.

19. The seal of claim 14, wherein the collar portion has an oval-shaped cross-section when fully expanded.

20. The seal of claim 14, wherein the collar portion has a polygonal-shaped cross-section when fully expanded.

21. The seal of claim 14, wherein the collar portion fully surrounds the opening through the seal.

22. The seal of claim 21, wherein the opening is oval-shaped.

23. The seal of claim 21, wherein the opening is polygonal-shaped.

24. A method of sealing an exhaust pipe of an aircraft, the method comprising:
connecting a seal to a tail cone, the seal comprising:
a collar portion of resilient material bounding an opening that is configured to receive the exhaust pipe therethrough; and
a shroud portion connected to the collar portion and extending radially outward therefrom;
fluidly coupling a vacuum source with the collar portion;
contracting the collar portion to expand a diameter of the opening to be larger than an outer diameter of the exhaust pipe;
axially sliding the seal over the exhaust pipe;
decoupling the vacuum source from the valve; and
automatically expanding the resilient material of the collar portion to form a generally fluid-tight seal around the exhaust pipe.
